(19) United States
(12) Patent Application Publication
(10) Pub. No.: US 2021/0084848 A1
(43) Pub. Date: Mar. 25, 2021

(54) WATER SYSTEM FOR HYDROPONIC GROWING

(71) Applicant: Shane McKenna, Holladay, UT (US)

(72) Inventor: Shane McKenna, Holladay, UT (US)

(21) Appl. No.: 17/027,643

(22) Filed: Sep. 21, 2020

Related U.S. Application Data
(60) Provisional application No. 62/903,208, filed on Sep. 20, 2019.

(51) Int. Cl. A01G 31/02; A01G 27/00

(52) U.S. Cl. CPC A01G 31/02; A01G 27/005; A01G 27/006

(57) ABSTRACT

Disclosed herein is a hydroponic system comprising a water container, a gas pump disposed within the water container, and an air chamber disposed around the gas pump. The hydroponic system also includes an air line extending into the air chamber to drive air into the air chamber water within the water container, and an air bell disposed within the water container to capture the air from the air line, wherein the air bell maximizes the surface area of the water with the captured air. Also disclosed is a system and a method for implementing the system.

### CROSS-REFERENCES TO RELATED APPLICATIONS

This application claims the benefit of and claims priority to U.S. Provisional Patent Application No. 62/903,208 entitled “WATER SYSTEM FOR HYDROPONIC GROWING” and filed on Sep. 20, 2019 for Shane McKenna, which is incorporated herein by reference.

### FIELD

This invention relates to water systems and more particularly relates to a water system in a hydroponic environment.

### BACKGROUND

Hydroponics is one approach to growing plants without soil using mineral nutrient solutions in water. Various water systems have been utilized in conjunction with hydroponics, but each have shortcomings, problems, and disadvantages. The subject matter of the present application has been developed in response to the present state of the art, and in particular, in response to the problems and disadvantages associated with conventional water systems that have not yet been fully solved by currently available techniques. Accordingly, the subject matter of the present application has been developed to provide embodiments of a system, an apparatus, and a method that overcome at least some of the shortcomings of prior art techniques.

### SUMMARY

An apparatus for a hydroponic system is disclosed. A system and method also perform the functions of the apparatus. In certain examples, the hydroponic system includes a water container, a gas pump disposed within the water container, and an air chamber disposed around the gas pump. The hydroponic system also includes an air line extending into the air chamber to drive air into the air chamber water within the water container, and an air bell disposed within the water container to capture the air from the air line, wherein the air bell maximizes the surface area of the water with the captured air.

### BRIEF DESCRIPTION OF THE DRAWINGS

In order that the advantages of the subject matter may be more readily understood, a more particular description of the subject matter briefly described above will be rendered by reference to specific embodiments that are illustrated in the appended drawings. Understanding that these drawings depict only typical embodiments of the subject matter and are not therefore to be considered to be limiting of its scope, the subject matter will be described and explained with additional specificity and detail through the use of the drawings, in which:

FIG. 1 is a cross-sectional view of a hydroponic system, according to one or more embodiments of the present disclosure;

FIG. 2 is a cross-sectional view of a water system, according to one or more embodiments of the present disclosure;

FIG. 3 is a cross-sectional view of region A of FIG. 2, according to one or more embodiments of the present disclosure;

FIG. 4 is a cross-sectional view of the water system of FIG. 2, according to one or more embodiments of the present disclosure;

FIG. 5 is a cross-sectional view of region B of FIG. 4, according to one or more embodiments of the present disclosure;

FIG. 6 is a side elevation view of the pump and air bell, according to one or more embodiments of the present disclosure;

FIG. 7 is a bottom elevation view of the pump and air bell of FIG. 6, according to one or more embodiments of the present disclosure;

FIG. 8 is a lower perspective view of the pump and air bell of FIG. 6, according to one or more embodiments of the present disclosure;

FIG. 9 is an upper perspective view of the pump and air bell of FIG. 6, according to one or more embodiments of the present disclosure;

FIG. 10 is a lower perspective view of an air bell, according to one or more embodiments of the present disclosure;

FIG. 11 is an upper perspective view of a first pump body, according to one or more embodiments of the present disclosure;

FIG. 12 is a bottom perspective view of the first pump body of FIG. 11, according to one or more embodiments of the present disclosure;

FIG. 13 is a top perspective view of the first pump body of FIG. 11, according to one or more embodiments of the present disclosure;

FIG. 14 is an upper perspective view of a second pump body, according to one or more embodiments of the present disclosure;

FIG. 15 is a bottom perspective view of the second pump body of FIG. 14, according to one or more embodiments of the present disclosure;

FIG. 16 is a flow diagram illustrating a method for operating a hydroponic system, according to one or more embodiments of the present disclosure;

FIG. 17 is a cross-sectional view diagram of another hydroponic system, according to examples of the subject disclosure;

FIG. 18 is a cross-section of a partial view of the pump, according to examples of the subject disclosure;

FIG. 19 is a perspective view drawing of the selector, according to examples of the subject disclosure;

FIGS. 20a and 20b are perspective view diagrams of the pump body, according to examples of the subject disclosure; and

FIG. 21 is a perspective view diagram of the pump insert, according to examples of the subject disclosure.

### DETAILED DESCRIPTION

The described features, structures, advantages, and/or characteristics of the subject matter of the present disclosure may be combined in any suitable manner in one or more embodiments and/or implementations. In the following description, numerous specific details are provided to impart a thorough understanding of embodiments of the subject matter of the present disclosure. One skilled in the relevant art will recognize that the subject matter of the present disclosure may be practiced without one or more of the specific features, details, components, materials, and/or methods of a particular embodiment or implementation. In other instances, additional features and advantages may be recognized in certain embodiments and/or implementations that may not be present in all embodiments or implementations. Further, in some instances, well-known structures, materials, or operations are not shown or described in detail to avoid obscuring aspects of the subject matter of the present disclosure. The features and advantages of the subject matter of the present disclosure will become more fully apparent from the following description and appended claims, or may be learned by the practice of the subject matter as set forth hereinafter.

Reference throughout this specification to “one embodiment,” “an embodiment,” or similar language means that a particular feature, structure, or characteristic described in connection with the embodiment is included in at least one embodiment of the present disclosure. Appearances of the phrases “in one embodiment,” “in an embodiment,” and similar language throughout this specification may, but do not necessarily, all refer to the same embodiment. Similarly, the use of the term “implementation” means an implementation having a particular feature, structure, or characteristic described in connection with one or more embodiments of the present disclosure, however, absent an express correlation to indicate otherwise, an implementation may be associated with one or more embodiments.

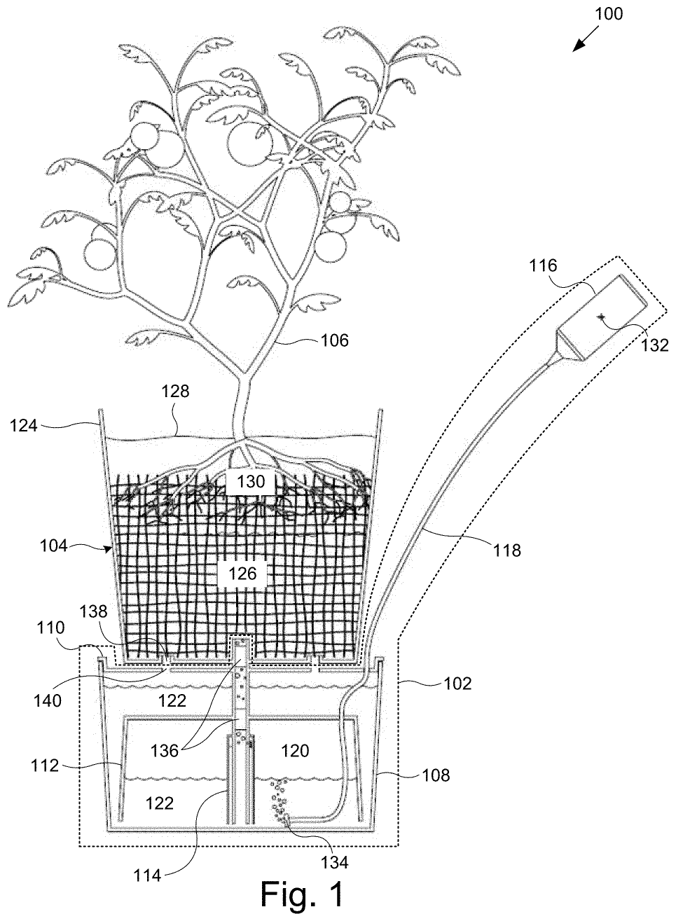

Referring to FIG. 1, a cross-sectional view of a hydroponic system 100, is shown. In the illustrated embodiment, the hydroponic system 100 includes a water system 102 and a media system 104. In the illustrated embodiment, a tomato plant 106 is also shown for context.

The illustrated embodiment of the water system 102 includes a water container 108. The water system 102 is also shown with a lid 110 positioned to close a top of the water container 108. The water system 102 also includes an air bell 112 positioned within the water container 108. The water system 102 also includes a pump 114 arranged within the air bell 112 and extending from proximate a bottom of the water container 108 up through the lid 110 and into the media system 104. The illustrated embodiment of the water system 102 also includes an air source 116 and an air line 118. In the illustrated embodiment, the air line 118 passes through the lid 110 and the air bell 112 to introduce air 120 into the air bell 112. In the illustrated embodiment, the air line 118 is positioned to be submerged in water 122 within the air bell 112.

The media system 104 includes a media container 124. In the illustrated embodiment, the media container 124 is positioned on the lid 110 of the water system 102. The media system 104, as illustrated, also includes a grow media 126 disposed within the media container 124. The illustrated media system 104 also includes soil 128. The illustrated tomato plant 106 also includes roots 130 disposed in the soil 128 and the grow media 126.

In some embodiments, the air source 116 delivers air 120 through the air line 118 and into the air bell 112 within the water container 108. In the illustrated embodiment, the air source 116 is a bottle that can be squeezed (human-powered) or otherwise pumped to drive air into the air bell 112.

In the illustrated embodiment, the air supply 116 may be a bottle with a hole 132 disposed in the bottle. The hole 132 may be covered with a finger and the bottle squeezed to drive the air into the air line 118. In other embodiments, the air source 116 is an electric pump, air compressor, or other device capable of driving air into the air bell 112. At least one of the air source 116 and the air line 118 may include a check valve to allow one-way pumping of the air into the water container 108. At least one of the air source 116 and the air line 118 may include backflow or reverse siphon protection to prevent water 122 from passing through the air line 118 out of the water container 108.

The air line 118 may be a continuous line extending from the air source 116 to the interior of the air bell 112. In some embodiments, the air line 118 may include one or more couplers joining multiple separate sections of the air line 118 together. In some embodiments, the couplers may be positioned at one or more of the lid 110, the air bell 112, and the like. The couplers may be fixed and/or sealed to the corresponding structure, such as the lid 110 and the air bell 112, to provide a sealed connection without having to pass and seal the air line 118 through the corresponding structures of the water system 102.

With the air line 118 positioned under the air bell 112 and submerged within the water 122, the air 120 delivered by the air line 118 bubbles up through the water 122 and into the air bell 112. The bubbling of the air 120 through the water 122 aerates the water 122. The air line 118 may include a weight 134 on the end to maintain the air line 118 at the bottom of the water container 108 below the air bell 112. Aeration of the water provides multiple advantages. For example, aeration of the water 122 is beneficial for providing necessary nutrients and elements to the root zone 130 of the plant 106 and to support microbial growth and population for nutrient processing in the water system 102.

For example, oxygenated water 122 may support the presence of aerobic bacteria in the zone below the air bell 112 which may actively kill pathogens and break down other unwanted compounds in the water 122. This creates and supports an aerobic zone beneath the air bell 112. Additionally, the water 122 that is external to the air bell 112 is less oxygenated which primarily supports more anaerobic bacteria than the more oxygenated water 122 within/below the air bell 112. In some embodiments, the anerobic bacteria is capable of breaking down organic compounds. The balance of anaerobic and aerobic zones processes the water through anaerobic and aerobic activity to maintain a healthy state of the hydroponic system 100.

Additional oxygenation occurs as air 120 is pumped under the air bell 112 and comes to pressure with the water 122 surrounding the air bell 112. The air-water surface area and pressure of the air 120 at the water 122 within the air bell 112 drives oxygen into the water 122 and oxygenates the water 122. As such, the rate of oxygenation and saturation level may vary depending upon the surface area and the air pressure within the air bell 112.

The air pressure also drives the pump 114. In steady-state, the pump 114 is flooded with water 122. As air pressure builds within the air bell 112 in response to incoming air from the air source 116, air 120 seeps into the pump 114. This serves to further oxygenate the water 122 within the pump 114 and, once enough air 120 builds in the pump 114, a bubble or a 136 is created within the pump 114. The sizing and frequency of the air slugs 136 are dependent upon variables of the pump 114 which are discussed below. The air slug 136 rises up through the pump 114 and forces water 122 ahead of the air slug 136 due to surface tension between the air slug 136 and the water 122. The formation and rise of the air slug 136 drives water 122 into the grow media 126 within the media container 124 of the media system 104.

The grow media 126 receives the water 122 driven ahead of the air slugs 136 and carries the water 122 using capillary action and other mechanics described in U.S. patent application Ser. No. 16/051,261 which is incorporated herein by reference in its entirety. The water 122 is delivered to the roots 130 of the plant 106. Excess water 120 is drained off by the grow media 126 through one or more media drains 138 in the media container 124. The water 122 is then received back into the water container 108 via one or more water intakes 140 formed in the lid 110. In the illustrated embodiment, the media drains 138 and the water intakes 140 are aligned. In other embodiments, one or more of the media drains 138 are not aligned with one or more of the water intakes 140.

In some embodiments, the media drains 138 allow extra water 122 to leave the media container 124 whether that is water 122 introduced by the pump 114, into the media container 124 from above, such as rain, hand-watering, etc., or by other means. The water intakes 140 allow for refilling of the water container 108 with additional water.

Benefits of the system are increased efficiency in water use and a reduction in power demand relative to comparable hydroponic and other irrigation systems. In some embodiments, the illustrated hydroponic system 100 requires no outside power apart from a user squeezing, or otherwise operating, the air supply to drive air 120 into the air bell 112. Additionally, the hydroponic system 100 does not require soil 128 as the grow media 126 is a soil replacement. However, the hydroponic system 100 is also capable of utilizing soil 128 to introduce nutrients, minerals, and organic materials into the hydroponic system 100. The soil 128 and grow media 126 facilitate the addition of worms, nematodes, fungus, and other beneficial organisms to further benefit the hydroponic system 100. The water draining and recycling capability of the hydroponic system 100 further reduces the skill and knowledge requirement to water and grow plants 106 without sophisticated sensors and other systems which add substantial cost, power requirements, and complexity.

Some embodiments facilitate a single plant 106 while other embodiments are capable of facilitating a plurality of plants 106 within the hydroponic system 100. Embodiments of the hydroponic system 100 are easily scalable to match specific uses, infrastructure, levels of automation, and situations. Additionally, components of the system 100 may be sourced locally with repurposed materials. For example, the air supply 116 may be a used water bottle while the water container 108 and the media container 124 may be used buckets. In other words, the hydroponic system 100 disclosed herein is flexible in location, user ability, and cost. This makes the system 100 advantageous for use in third-world, low-income, or other environments which benefit from low-cost, high-efficiency systems with long lifespan and life-sustaining food generation capability. Further embodiments include longevity increasing variations such as UV shielding, structural reinforcements, evaporation covers, and the like.

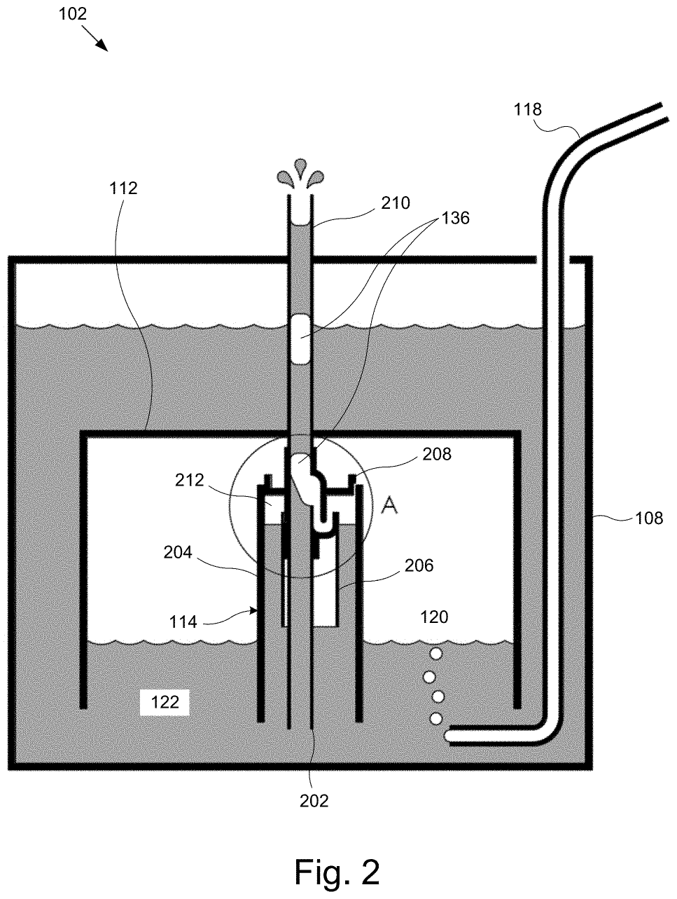

Referring to FIG. 2, a cross-sectional view of the water system 102 is shown. In the illustrated embodiment, the pump 114 includes a pump inlet 202, an air chamber 204, a first pump body 206, a second bump body 208, and a pump outlet 210.

In the illustrated embodiment, the pump inlet 202 is coupled to the first pump body 206 and extends downward to the water 122 below the air bell 112. The pump inlet 202 supplies water 122 to the pump 114 for upward delivery from the pump 114. In some embodiments, the space around the first pump body 206 and the air chamber 204 creates a laminar flow to improve the uniformity and efficiency of the air slugs 136. The pump inlet 202 may be a circular cylinder or a non-circular cylinder and may also produce a flow effect to facilitate creation of the air slugs 136.

In some embodiments, the air chamber 204 surrounds the pump inlet 202 and the first pump body 206 and couples to the second pump body 208. The air chamber 204 extends from the second pump body 208 down to the water 122 below the air bell 112. The air chamber 204 supports formation of an air pocket 212 which is used by the first pump body 206 and the second pump body 208 to create the air slugs 136.

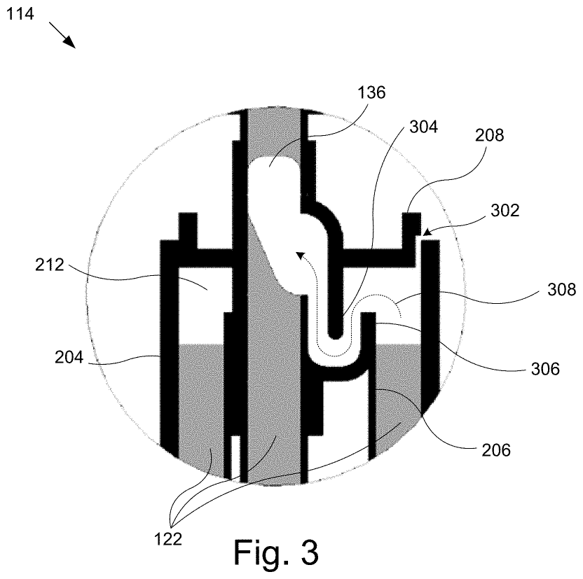

In some embodiments, the first pump body 206 forms a lower barrier to hold water and facilitate formation of the air slugs 136. The second pump body 208 orients with the first pump body 206 to form the upper barrier to facilitate formation of the air slugs 136. In the illustrated embodiment, the pump outlet 210 carries the water 122 and air slugs 136 away from the pump 114. The length of the pump outlet 210 may be varied based on the use and the size of the air slugs 136 generated by the pump 114. The illustrated embodiment also includes a region A which is described in further detail below with reference to FIG. 3.

Referring to FIG. 3, a cross-sectional view of region A of FIG. 2 is shown. In the illustrated embodiment, air seeps into the pump 114 via an aperture 302. In some embodiments, the rate at which the air seeps into the aperture 302 is dependent upon the size of the aperture 302 and a pressure of the air within the air bell 112. As the air seeps into the pump 114, it forms the air pocket 212.

In the illustrated embodiment, the second pump body 208 includes an upper barrier which extends downward from the second pump body 208. The illustrated embodiment of the first pump body 206 includes a lower barrier 306 which extends upward from the first pump body 206. In the illustrated embodiment, the upper barrier 304 and the lower barrier 306 form a channel 308.

The air pocket 212 increases in size and volume within the pump 114 as air continues to seep into the pump via the aperture 302. The growing air pocket 212 pushes the water 122 down within the channel 308. As the air pocket 212 reaches the lower end of the upper barrier 304 and the surface tension of the water 122 alongside the upper barrier 304 is overcome, the air rushes into the center of the pump 114 to form the air slug 136 in a gulping movement. In some embodiments, movement and momentum of the water 122 rising toward the channel 308 over the lower barrier 306 may further force air from the air pocket 212 along the channel 308 and into forming the air slug 136.

The surface tension of the air slug 136 and relatively lower density prevents water above the air slug 136 from passing around the air slug 136 and the water trapped above the air slug 136 is carried upward along the pump outlet 210.

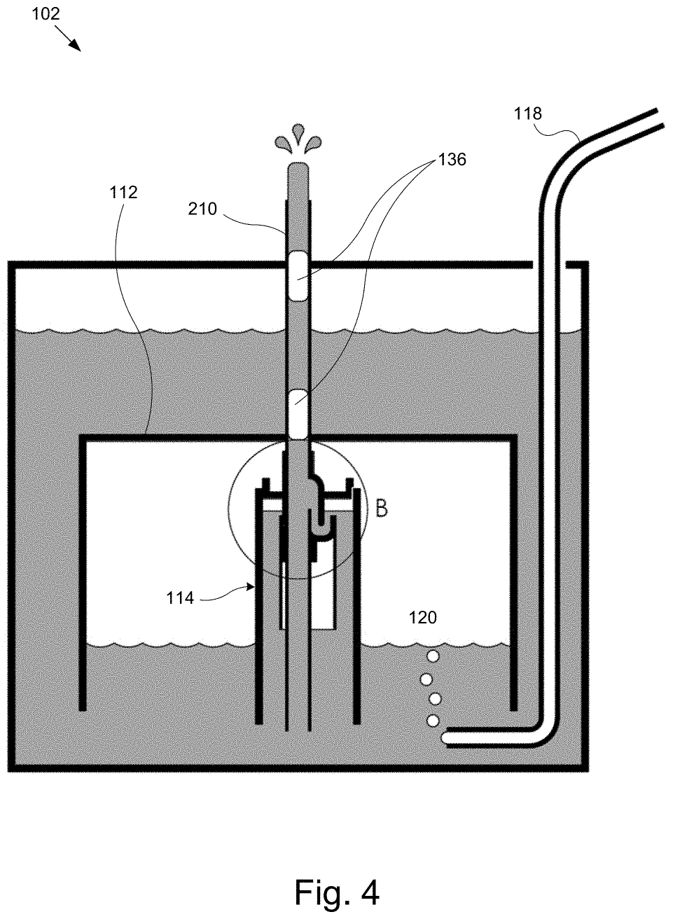

Referring to FIG. 4, a cross-sectional view of the water system 102 of FIG. 2 is shown. In the illustrated embodiment, the pump 114 has reset and the air slugs 136 created by the pump 114 are traveling upward along the pump outlet 210. In this state, the water system 102 is prepared to receive additional air 120 which may be driven into the water system 102 via the air line 118.

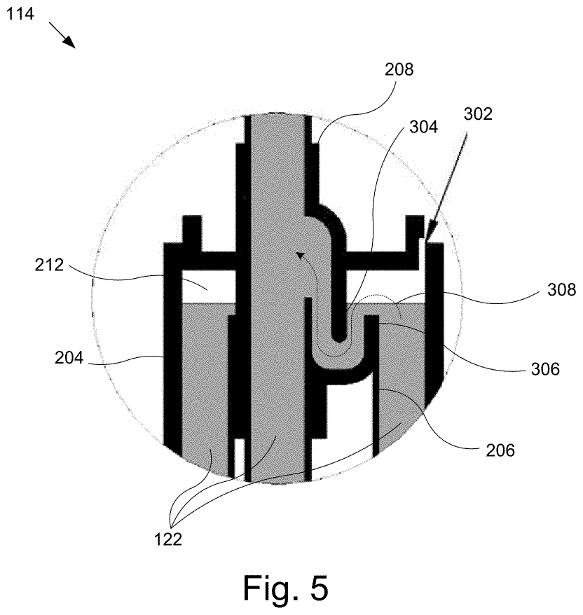

Referring to FIG. 5, a cross-sectional view of region B of FIG. 4 is shown. In the illustrated embodiment, the water 122 has risen above the lower barrier 306 of the first pump body 206 and filed the channel 308. In some embodiments, this terminates the previous air slug 136. Depending on the relative pressure of the air, additional air may continue to seep through the aperture 302 and increase the air pocket 212. In some embodiments, if the pressure of the air is insufficient, the pump 114 will remain in this state until additional air is introduced into the air bell 112 to increase the air pressure and drive additional air into the pump 114. If sufficient air pressure is attained, the air pocket 212 will increase in size and water will be forced out of the channel 308 until the event described above with reference to FIGS. 1-4 occurs.

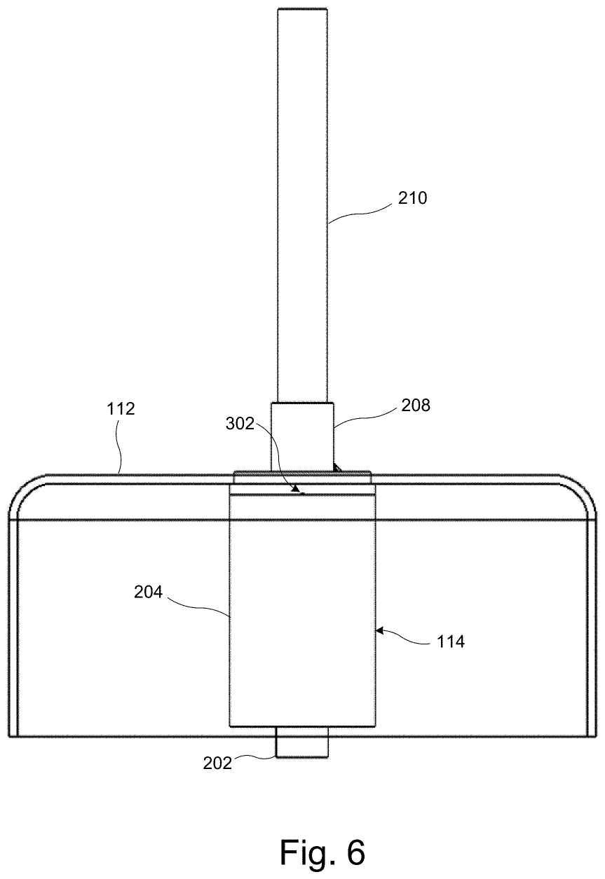

Referring now to FIG. 6, a side elevation view of the pump 114 and air bell is shown. In the illustrated embodiment, the second pump body 208 is positioned to correspond with and couple to the air bell 112. The second pump body 208 and the air bell 112 may be coupled with an adhesive, welding, bonding, or other material joining. In other embodiments, the second pump body 208 and the air bell 112 may be joined by a mechanical joining such as a seal or gasket. This mechanical joining may also include a threaded, clipped, friction fit, or other joining. In other embodiments, the second pump body 208 and the air bell 112 are formed together as a unitary structure.

While the illustrated embodiment shows the second pump body 208 corresponding to and coupling with the air bell 112 other components of the pump 114 may couple to the air bell 112. For example, the air chamber 204 or the pump outlet 210 may couple to the air bell 112. Additionally, while the pump 114 is shown as disposed centrally within the air bell 112, in some embodiments, the pump 114 may be disposed to one side or other within the air bell 112 so as not to be centrally located within the air bell 112.

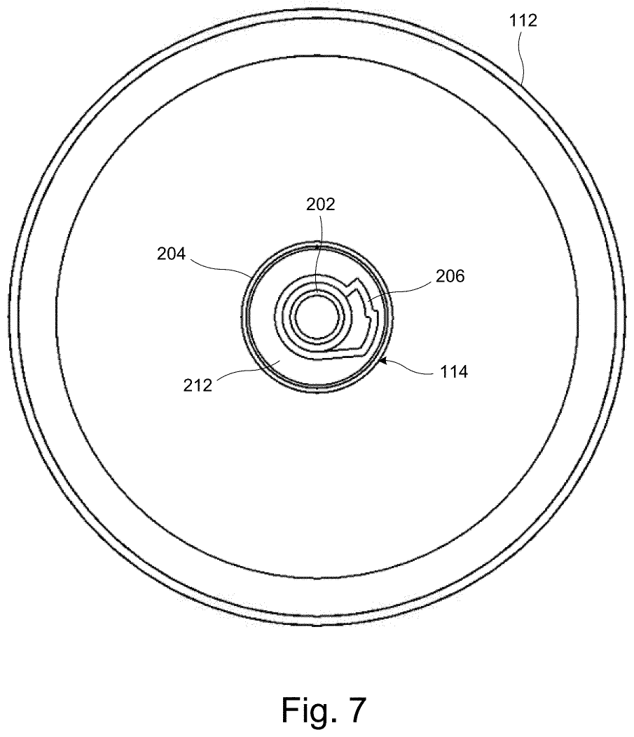

Referring to FIG. 7, a bottom elevation view of the pump 114 and air bell 112 of FIG. 6 is shown. In the illustrated embodiment, the relative position of the air chamber 204, the first pump body 206, and the pump inlet 202 within the air bell 112 may be seen. In the illustrated embodiment, the air pocket 212 of FIG. 5 is disposed between the first pump body 206 and the air chamber 204.

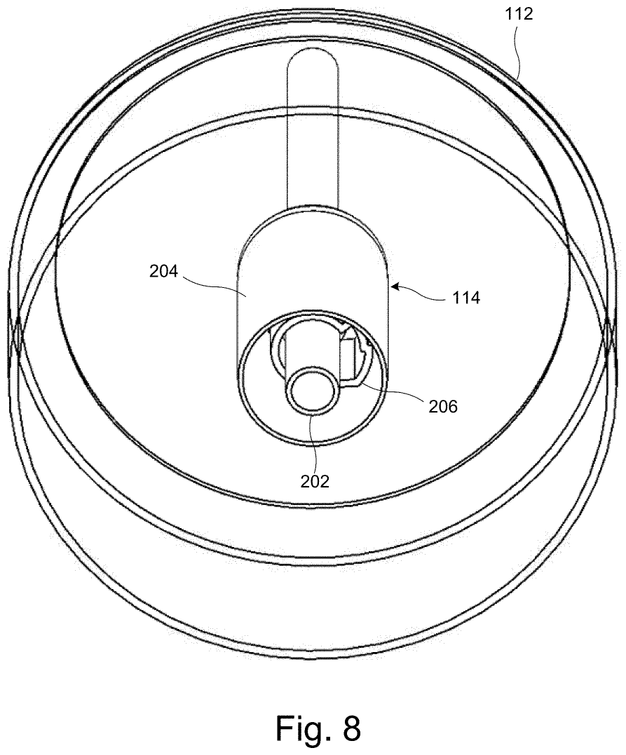

Referring to FIG. 8, a lower perspective view of the pump 114 and air bell 112 of FIG. 6 is shown. In the illustrated embodiment, the pump inlet 202, the first pump body 206, the air chamber 204, and the air bell 112 are coaxially aligned. In other embodiments, one or more of the pump inlet 202, the first pump body 206, the air chamber 204, and the air bell 112 may be axially offset from one or more of the pump inlet 202, the first pump body 206, the air chamber 204, and the air bell 112.

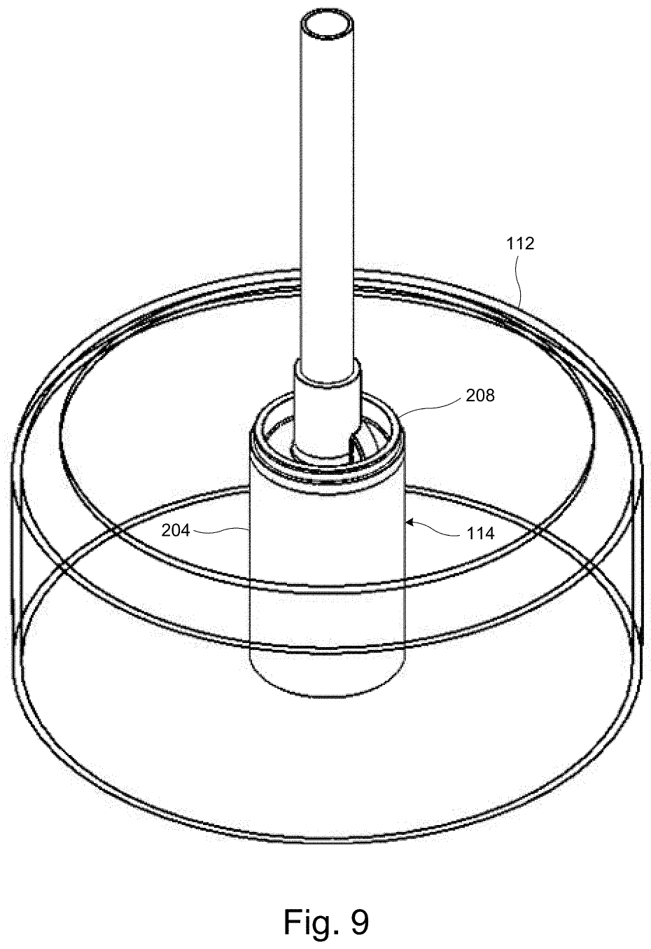

Referring to FIG. 9, an upper perspective view of the pump 114 and air bell 112 of FIG. 6 is shown. In some embodiments, the second pump body 208 engages with the air bell 112. In other embodiments, the air chamber 204 of the pump 114 engages with the air bell 112.

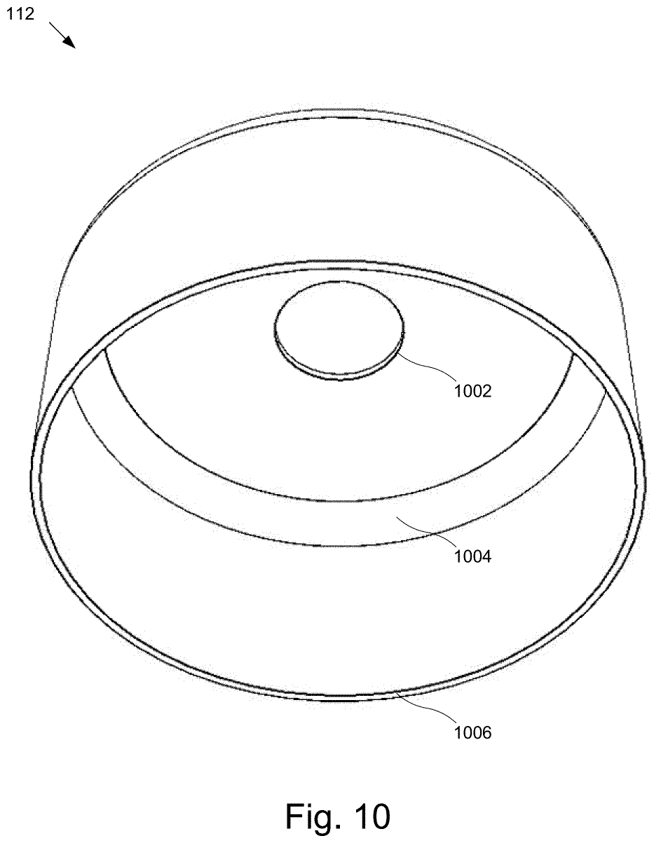

Referring to FIG. 10, a lower perspective view of the air bell 112 is shown. In the illustrated embodiment, the air bell 112 includes a pump aperture 1002, a shoulder 1004, and a lower edge 1006. In some embodiments, the pump aperture 1002 is formed in the air bell 112 to be centrally located. In other embodiments, the pump aperture 1002 may be offset from a center of the air bell 112.

In some embodiments, the air bell 112 has a rounded shoulder 1004. In other embodiments, the air bell 112 has an angled or non-rounded shoulder 1004. For example, the air bell 112 may have a shoulder 1004 which forms a right angle or which has a flat shoulder.

In the illustrated embodiment, the lower edge 1006 of the air bell 112 is smooth. In other embodiments, the lower edge 1006 of the air bell 112 may be serrated, scalloped, or include legs, or other structures which may be suitable to contact a bottom of the water container 108 of FIG. 1 without preventing water from flowing into the air bell 112. In some embodiments, the air bell 112 may include a particulate screen or other filter.

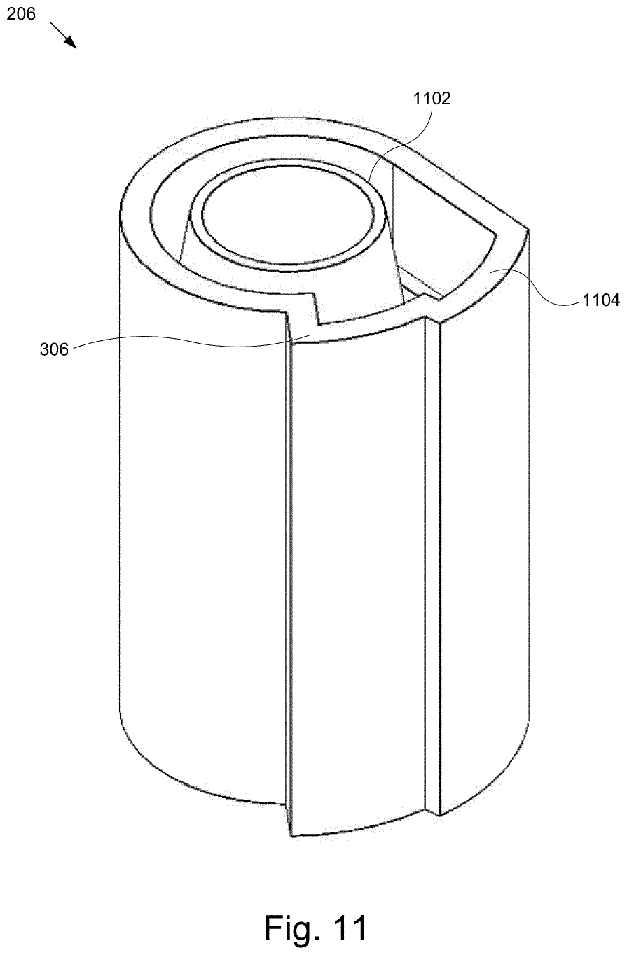

Referring to FIG. 11, an upper perspective view of the first pump body 206 is shown. In the illustrated embodiment, the first pump body 206 includes an outlet coupler 1102, a wall offset 1104, and the lower barrier 306. In some embodiments, the outlet coupler 1102 facilitates connection of the first pump body 206 to one or both of the pump outlet 210 and the second pump body 208. In some embodiments, the outlet coupler 1102 facilitates a friction fit, a glue coupling, or the like. In the illustrated embodiment, the outlet coupler 1102 is tapered. In other embodiments, the outlet coupler 1102 is more or less tapered or is not tapered.

In some embodiments, the wall offset 1104 is formed in the first pump body 206 to facilitate connection with the second pump body 208. The lower barrier 306 forms an initial portion of the channel 308 shown in FIG. 3 and FIG. 5. While both the wall offset 1104 and the lower barrier 306 are shown as extending a full length of the first pump body 206, in other embodiments, at least one of the wall offset 1104 and the lower barrier 306 do not extend the full length of the first pump body 206.

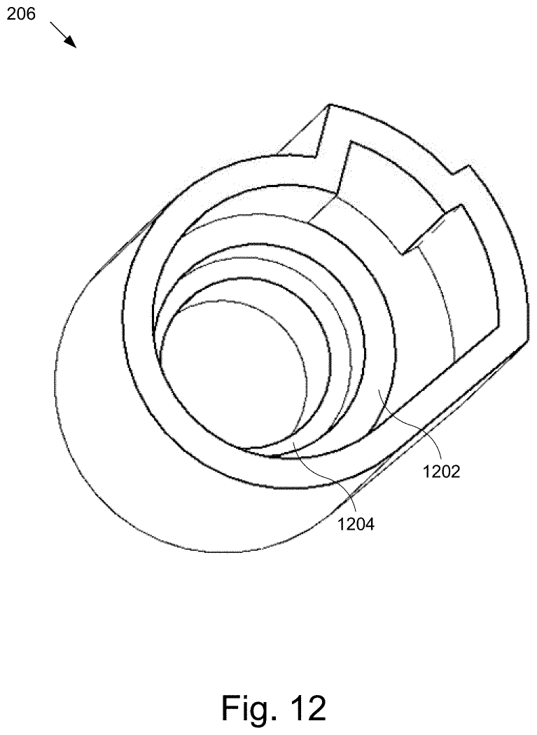

Referring to FIG. 12, a bottom perspective view of the first pump body 206 of FIG. 11 is shown. In the illustrated embodiment, the first pump body 206 includes an intake collar 1202 and an intake seat 1204. In some embodiments, the intake collar 1202 has a diameter sufficient to receive the pump inlet 202. Similarly, the intake seat 1204 may be sized to seat the pump inlet 202. In some embodiments, the first pump body 206 has an internal diameter, at the inlet seat 1204 substantially the same as an internal diameter of the pump inlet 202.

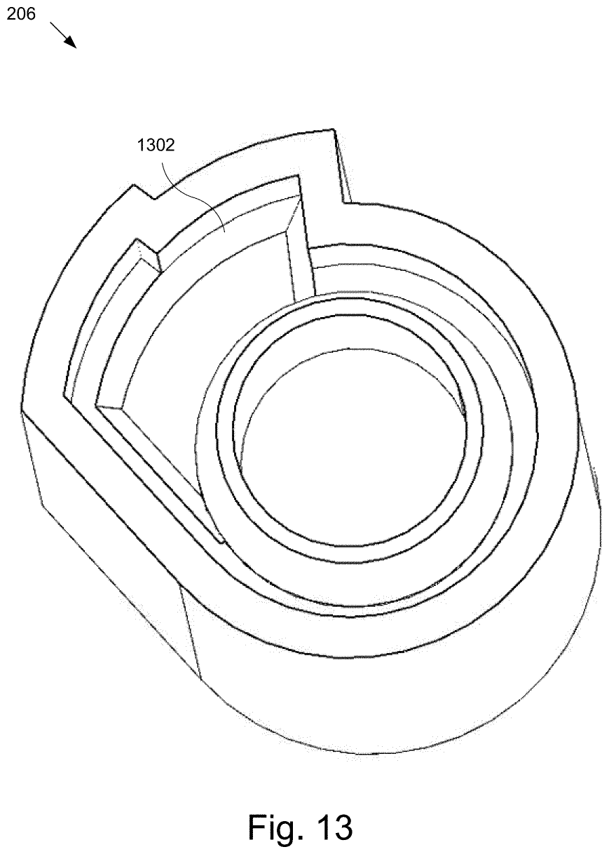

Referring to FIG. 13, a top perspective view of the first pump body 206 of FIG. 11 is shown. In the illustrated embodiment, the first pump body 206 includes a chamfered corner 1302. In some embodiments, the chamfered corner 1302 facilitates better flow through the channel 308 during creation of an air slug 136. In other embodiments, the chamfered corner 1302 reduces build-up of trapped particulates.

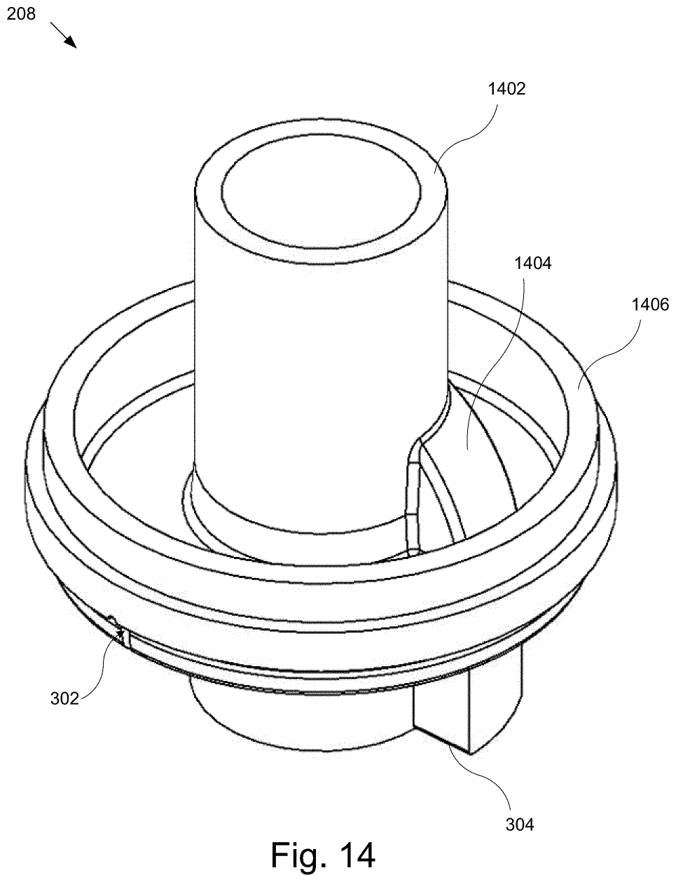

Referring to FIG. 14, an upper perspective view of the second pump body 208 is shown. In the illustrated embodiment, the second pump body 208 includes the aperture 302 and the upper barrier 304. Additionally, as illustrated, the second pump body 208 includes an outlet collar 1402, a channel housing 1404, and a support collar 1406.

In some embodiments, the outlet collar 1402 facilitates coupling of the pump outlet 210 to the second pump body 208. The outlet collar 1402 may be tapered or include a bonding surface to facilitate a friction or glue coupling.

In the illustrated embodiment, the channel housing 1404 is formed in the second pump body 208 to form the channel 308 within the pump 114. In the illustrated embodiment, the channel housing 1404 is curved toward the interior of the second pump body 208. In other embodiments, the channel housing 1404 may be straight. Other designs and shapes of the channel housing 1404 may be used. In the illustrated embodiment, the channel housing 1404 continues to the bottom of the second pump body 208 to form the upper barrier 304.

In the illustrated embodiment, the support collar 1406 is disposed along an outer edge of the second pump body 208. In some embodiments, the support collar 1406 provides structural support to the second pump body 208. In other embodiments, the support collar 1406 provides at location at which the second pump body 208 may be coupled to the air bell 112 or another component.

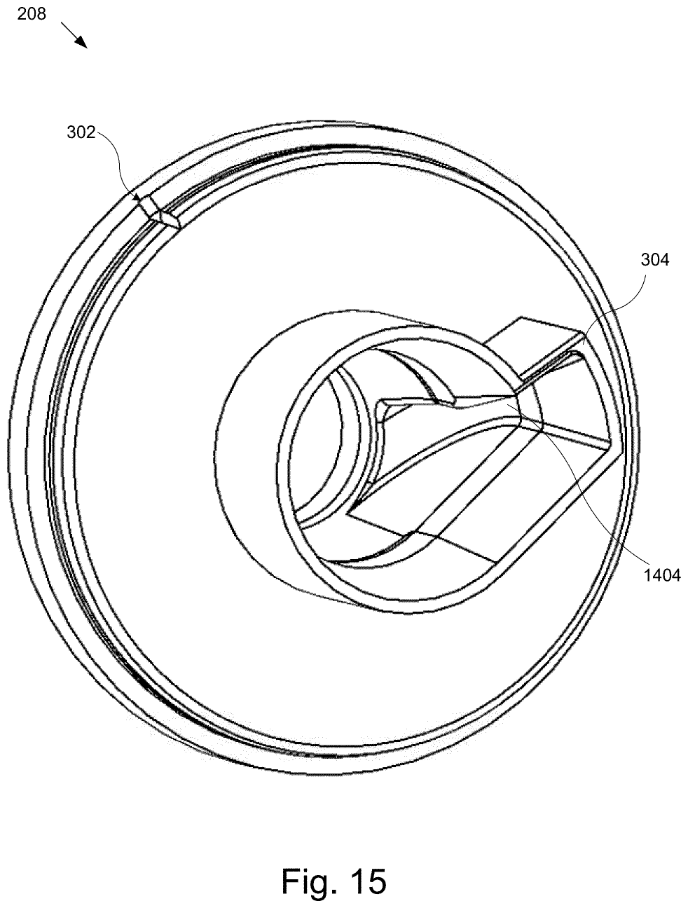

Referring to FIG. 15, a bottom perspective view of the second pump body 208 of FIG. 14 is shown. In the illustrated embodiment, the channel housing 1404 is shown as extending to form the upper barrier 304. Additionally, the illustrated embodiment shows the form of the aperture 302 which allows air to seep into the pump 114 between the second pump body 208 and the air chamber 204 to form the air pocket 212. The size and shape of the aperture 302 may be varied to adjust the rate at which air seeps into the pump 114. This can affect the size and frequency at which air slugs 136 are generated.

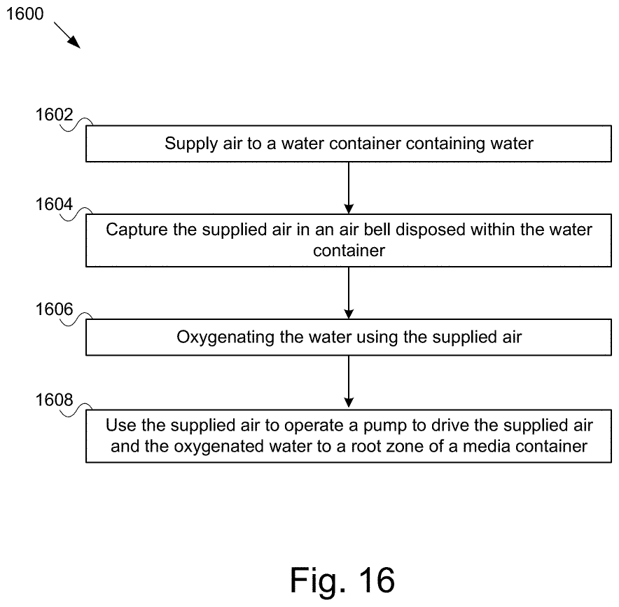

Referring to FIG. 16, a flow diagram illustrating a method 1600 for operating a hydroponic system is shown. In the illustrated embodiment, the method 1600 includes, at block 1602, supplying air to a water container containing water. As described above, the air may be supplied by a human-powered air supply such as a bottle or other pump. The air may also be supplied by an electrical or other non-human powered pump.

At block 1604, the method 1600 includes capturing the supplied air in an air bell disposed within the water container. The air bell may be submerged within the water container and receive the air via an air line running into the water container and position such that the air enters and is captured by the air bell.

At block 1606, the method 1600 also includes oxygenating the water using the supplied air. In some embodiments, the water is oxygenated by bubbling the air supplied by the air source up through the water and into the bell. The water may also be oxygenated by creating a water-air boundary within the air bell which facilitates dissolution of the oxygen in the air into the water.

At block 1608, the method 1600 further includes using the supplied air to operate a pump to drive the supplied air and the oxygenated water to a root zone of a media container. In some embodiments, the pump shown in FIG. 2 and described herein is used to drive oxygenated water and air to the root zone of a plant within a media container.

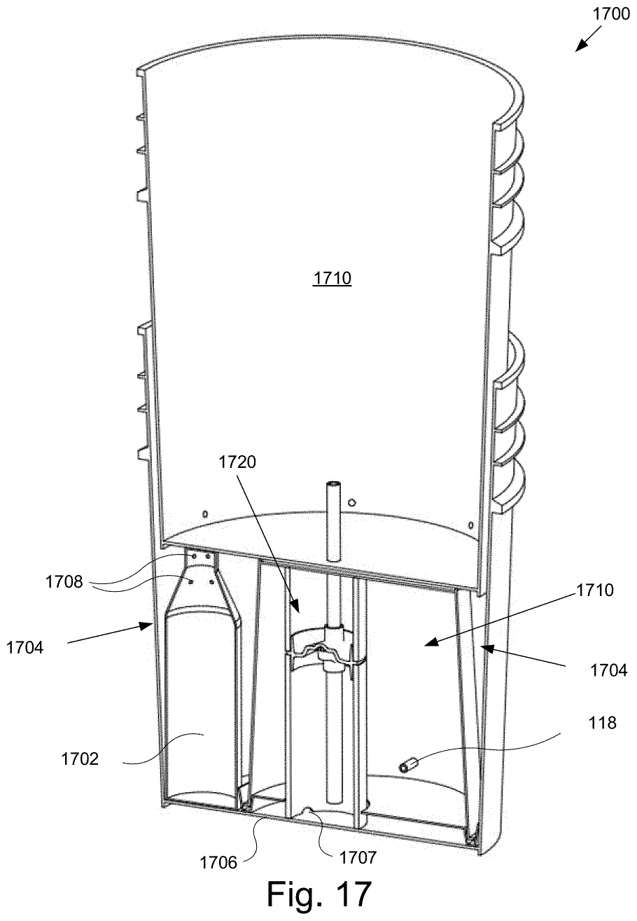

FIG. 17 is a cross-sectional view diagram of another hydroponic system 1700, according to examples of the subject disclosure. They hydroponic system 1700 incorporates many of the same elements described above with reference to FIGS. 1-15. In certain examples, the hydroponic system 1700 includes an anaerobic chamber 1702 that is fluidly coupled with the reservoir. The anaerobic chamber 1702 is configured to limit the exchange of oxygenated water into the reservoir 1704, thereby providing a low oxygen environment for anaerobic bacteria. In certain examples, the anaerobic chamber 1702 includes multiple holes 1708 at various elevations relative to a base 1706 near the top of the anaerobic chamber 1702.

Each time the air supply to the system 1700 is activated or deactivated, the level of the water in the reservoir 1704 changes due to water displacement within the air battery 1710. As the water level changes, the strategically placed multiple holes 1708 or openings at various levels in the anaerobic chamber 1702 facilitates the exchange of a percentage of the water inside the anaerobic chamber 1702. By controlling the on/off cycling of the air supply to the system 1700, both the amount of water delivered to the grow bin, and the amount of water exchanged in and out of the anaerobic chamber 1702 is controlled.

Beneficially, in the anaerobic chamber 1702, anaerobic bacteria breaks down organic and mineral compounds in the water nutrient mixture. Additionally, a contained anaerobic chamber 1702 with limited water exchange increases anaerobic bacteria quantity and variety, by limiting the amount of oxygenation that can occur. Further, a dedicated anaerobic chamber 1702 can be easily scaled in size and quantity in order to increase or decrease anaerobic bacteria activity to suit the particular production of various systems. Although depicted here inside of the hydroponic system 1700, the anaerobic chamber 1702 may be disposed outside of the reservoir 1704, and the limited anaerobic bacteria that escapes the anaerobic chamber is neutralized as it flows nearer to and within the highly oxygenated air battery and air pump. This eliminates the bacteria, however the plant available organic nutrients and minerals remain in suspension for delivery to the plant roots in the grow bin.

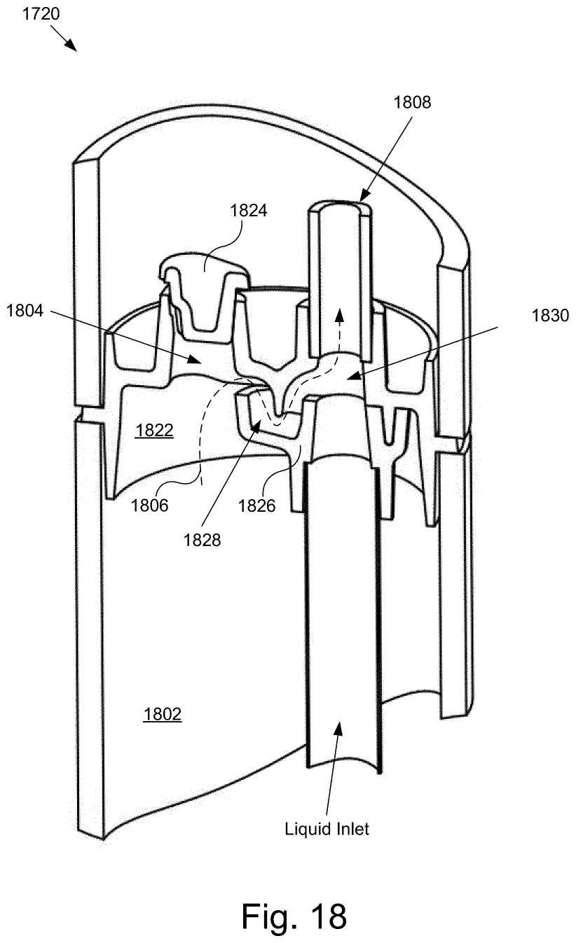

FIG. 18 is a cross-section of a partial view of the pump 1720, according to examples of the subject disclosure. The pump 1720, and its components, depicted in FIGS. 18-21, operates in a manner equivalent to the pump 114 described above with reference to FIGS. 1-15. The components of the pump, as will be described in greater detail below, may be molded (i.e., injection molded) and formed of resilient polymers, or other suitable materials. The pump 1720, in certain examples, is a gas-powered liquid pump located below a liquid level of either an open or sealed reservoir (e.g., reservoir 1704). Liquid pressure is provided by either gravity or pumped pressure. Gas pressure may be provided by an air pump that is manually, electrically, or mechanically operated. If a gas battery (e.g., air battery 1710) is part of the system, gas is collected in the sealed inverted battery housing. This gas displaces liquid to the outside of the air battery 1710 (i.e., air bell 112), increasing the depth of the reservoir 1704 and therefore increasing the pressure potential of the gas inside the gas battery.

The gas-powered liquid pump meters gas into the lower pump housing 1802 through select-able gas bleed ports 1707 (see FIG. 17). Gas accumulates in the molded gas cavity 1804, until enough volume of gas will overcome the siphon path 1806. A fixed gas volume then quickly seeks to return to atmosphere or a reduced gas pressure area. The only path to this reduced pressure area is through the pump 1720 outlet 1808 as depicted by the siphon path 1806. The gas forms a slug of gas in the pump outlet 1808, that pushes liquid up. There is some gas entrainment with the liquid, therefore some compounding of the gas and liquid can occur. The depicted pump 1720 beneficially includes significant improvements over prior gas-powered pumps by the reduction of plumbing tubing, seals and potentially leaking joints. The gas siphon action is accomplished by molded features that can be easily produced in diverse molding and casting techniques. These features are molded in such a way as to completely eliminate leakage that would otherwise disrupt proper siphon and gas slug development.

The pump 1720, beneficially has no mechanical mechanisms or moving parts, thereby reducing complexity, failure and maintenance and therefore increases pump life. The pump 1720 can be easily molded through various means, reducing materials, manufacturing and assembly complexity, and cost. The pump 1720 is usable in hazardous and explosive environments and used with highly acidic and caustic liquids, and is not limited to agriculture environments. Molding and casting allows a wider range of materials to be used for producing the pump, including, but not limited to, metals, polymers, ceramics, and composites thereof. As the pump itself is open to the surrounding liquid and gas pressures, the pressure forces acting on the pump are equalized. This allows the pump to function at any liquid depth with reduced consideration for material strength and thicknesses. Gas entrainment may be leveraged for compounding, for example, when used with air and water for fish and/or plant production, the water can become more oxygen saturated. In this application, the oxygen saturation can have significant advantages to fish and plant health while also reducing harmful pathogens. In another example, CO2 can be used to pump water for plants. Delivering both CO2 and water. Additionally, multiple pumps can be operated with a singular gas supply, and in the same liquid reservoir. This can have significant cost reduction and targeted delivery of liquids and gas in a wide variety of applications. In other examples, pumps can be staged to pump to significant elevations, can be sized to leverage liquid surface tension for higher liquid lifting, can be used for compounding gas with liquid, can be sized to use off the shelf tubing for the upper and lower housings, or these housings can be molded features of the pump.

In FIG. 18, the pump 1720 includes the lower pump housing 1802, an upper pump housing 1820, a pump body 1822, a gas inlet flow rate selector (“selector”) 1824, and a pump insert 1826. Each of these components may be press fit together, or alternatively, adhered to form the pump 1720. The pump body 1822, in certain examples is disposed between the upper pump housing 1820 and the lower pump housing 1802. A flange may extend outward radially from the pump body 1822 to support the upper pump housing 1820. In certain examples, the pump body 1822 includes an opening for receiving the selector 1824, and features that when mated with the pump insert, form a gas bowl 1828 and an inverted gas bowl 1830. The operation of gas bowl and inverted gas bowl is described in detail above with reference to at least FIG. 3, which discusses the upper barrier 304 and the lower barrier 306 that form opposing gas chambers identified as the gas bowl 1828 and the inverted gas bowl 1830. In certain examples, the selector 1824 controls the amount of air that is drawn into the pump body 1822. Channels formed in the exterior surface of the selector 1824 form pathways between the pump body 1822 and the selector 1824 through which air may pass. The selector 1824 is tunable to increase or decrease the amount of air that passes, as will be described below in greater detail.

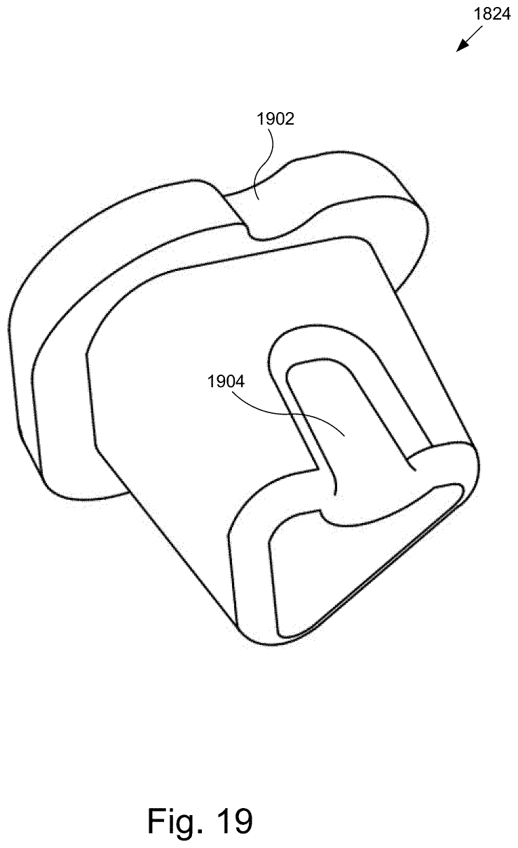

FIG. 19 is a perspective view drawing of the selector 1824, according to examples of the subject disclosure. The selector 1824, in certain examples includes an orientation indicator 1902 and a gas flow cavity 1904. The selector 1824, in certain examples, has a generally wedge-shaped cross-section as depicted in FIG. 19. The air flow rate to the pump body 1822 is adjustable by adjusting the position of the selector 1824 with respect to the pump body 1822.

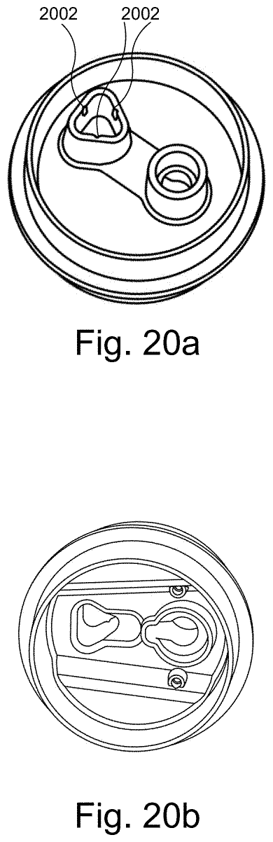

FIGS. 20a and 20b are perspective view diagrams of the pump body 1822, according to examples of the subject disclosure. In particular, FIG. 20a depicts a top view of the pump body 1822 and FIG. 20b depicts a bottom view of the pump body 1822. In FIG. 20a, notches 2002 in an opening for the selector 1824 allow an adjustable amount of air to pass between the selector 1824 and the pump body 1822.

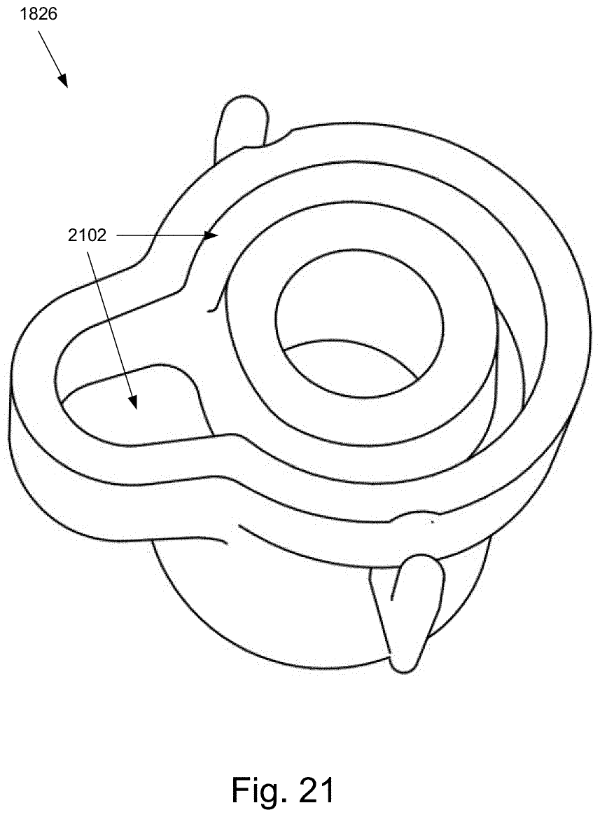

FIG. 21 is a perspective view diagram of the pump insert 1826, according to examples of the subject disclosure. The pump insert 1826 couples a liquid inlet to the pump body 1822. The pump insert 1826 is also formed with the lower barrier to form, together with the pump body 1822, the gas bowl 2102 and the inverted gas bowl. A ridge extending downward from the pump body 1822 extends into the gas bowl 2102 of the pump insert 1826 and forms the upper barrier described above.

In the above description, certain terms may be used such as “up,” “down,” “upper,” “lower,” “horizontal,” “vertical,” “left,” “right,” “over,” “under” and the like. These terms are used, where applicable, to provide some clarity of description when dealing with relative relationships. But, these terms are not intended to imply absolute relationships, positions, and/or orientations. For example, with respect to an object, an “upper” surface can become a “lower” surface simply by turning the object over. Nevertheless, it is still the same object. Further, the terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise. Further, the term “plurality” can be defined as “at least two.” Moreover, unless otherwise noted, as defined herein a plurality of particular features does not necessarily mean every particular feature of an entire set or class of the particular features.

Additionally, instances in this specification where one element is “coupled” to another element can include direct and indirect coupling. Direct coupling can be defined as one element coupled to and in some contact with another element. Indirect coupling can be defined as coupling between two elements not in direct contact with each other, but having one or more additional elements between the coupled elements. Further, as used herein, securing one element to another element can include direct securing and indirect securing. Additionally, as used herein, “adjacent” does not necessarily denote contact. For example, one element can be adjacent another element without being in contact with that element.

As used herein, the phrase “at least one of”, when used with a list of items, means different combinations of one or more of the listed items may be used and only one of the items in the list may be needed. The item may be a particular object, thing, or category. In other words, “at least one of” means any combination of items or number of items may be used from the list, but not all of the items in the list may be required. For example, “at least one of item A, item B, and item C” may mean item A; item A and item B; item B; item A, item B, and item C; or item B and item C. In some cases, “at least one of item A, item B, and item C” may mean, for example, without limitation, two of item A, one of item B, and ten of item C; four of item B and seven of item C; or some other suitable combination.

Unless otherwise indicated, the terms “first,” “second,” etc. are used herein merely as labels, and are not intended to impose ordinal, positional, or hierarchical requirements on the items to which these terms refer. Moreover, reference to, e.g., a “second” item does not require or preclude the existence of, e.g., a “first” or lower-numbered item, and/or, e.g., a “third” or higher-numbered item.

As used herein, a system, apparatus, structure, article, element, component, or hardware “configured to” perform a specified function is indeed capable of performing the specified function without any alteration, rather than merely having potential to perform the specified function after further modification. In other words, the system, apparatus, structure, article, element, component, or hardware “configured to” perform a specified function is specifically selected, created, implemented, utilized, programmed, and/or designed for the purpose of performing the specified function. As used herein, “configured to” denotes existing characteristics of a system, apparatus, structure, article, element, component, or hardware which enable the system, apparatus, structure, article, element, component, or hardware to perform the specified function without further modification. For purposes of this disclosure, a system, apparatus, structure, article, element, component, or hardware described as being “configured to” perform a particular function may additionally or alternatively be described as being “adapted to” and/or as being “operative to” perform that function.

The present subject matter may be embodied in other specific forms without departing from its spirit or essential characteristics. The described embodiments are to be considered in all respects only as illustrative and not restrictive. All changes which come within the meaning and range of equivalency of the claims are to be embraced within their scope.

What is claimed is:

1. A hydroponic system comprising:
a water container;
a gas pump disposed within the water container;
an air chamber disposed around the gas pump;
an air line extending into the air chamber to drive air into air chamber water within the water container; and
an air bell disposed within the water container to capture the air from the air line, wherein the air bell maximizes a surface area of the water with the captured air.

2. The hydroponic system of claim 1, where the air chamber forms an outer enclosure of the gas pump.

3. The hydroponic system of claim 1, where the gas pump comprises a pump body comprising an inner diameter to admit water through the pump, and a lower barrier extending upward from a top of the pump body.

4. The hydroponic system of claim 3, further comprising a lower pump housing coupled to the pump body and configured to direct liquid to the pump body.

5. The hydroponic system of claim 3, further comprising an upper pump housing coupled to the pump body, where the upper pump housing comprises an upper barrier extending downward into a gas bowl of the pump body.

6. The hydroponic system of claim 5, where the pump body and the upper pump housing form an air pocket and the upper barrier is offset from the lower barrier and forms a siphon path.

7. The hydroponic system of claim 6, further comprising a gas flow rate selector coupled to the pump body and configured to adjust an air rate into the pump body.

8. The hydroponic system of claim 7, where the upper barrier and the lower barrier are configured to form an air slug in response to air in an air cavity causing water to move past the upper barrier, and where the air slug drives water and air upward through the upper pump housing through an outlet.

9. The hydroponic system of claim 8, where the outlet is coupled to a root zone of a plant in a media container.

10. The hydroponic system of claim 1, where the air line is coupled to an air supply that is operable to generate air pressure.

11. The hydroponic system of claim 10, where the air supply is a hand pump.

12. The hydroponic system of claim 10, where the air supply is an air compressor.

13. The hydroponic system of claim 1, further comprising an anaerobic chamber disposed within the water container.

14. The hydroponic system of claim 13, where the anaerobic chamber is fluidly coupled with the water container, and includes a plurality of openings at different elevations with respect to a base of the water container.

15. A system comprising:
a fluid container; and
an air bell disposed within the fluid container to capture the air from the air line, wherein the air bell maximizes a surface area of the water with the captured air, wherein the air bell defines a primarily aerobic water zone within the air bell and a primarily anaerobic water zone outside the air bell.

16. A method for operating a hydroponic system, the method comprising:
supplying air to a water container containing water;
capturing the supplied air in an air bell disposed within the water container;
oxygenating the water using the supplied air;
using the supplied air to operate a pump to drive the supplied air and the oxygenated water to a root zone of a media container.

17. The method of claim 16, where the pump comprises a lower pump housing.

18. The method of claim 17, where the pump comprises a pump body having a gas bowl and a lower barrier extending from the pump body.

19. The method of claim 18, where the pump comprises an upper pump housing having an upper barrier extending into the gas bowl.

20. The method of claim 16, further comprising providing an anaerobic chamber disposed within the water container adjacent the pump.
